(19) United States
(12) Patent Application Publication
(10) Pub. No.: US 2022/0079192 A1
(43) Pub. Date: Mar. 17, 2022

(54) COMPOSITION FOR OUTER SKIN OF FILLING-WRAPPING FOOD

(71) Applicant: AJINOMOTO CO., INC., Tokyo (JP)

(72) Inventors: Masahiro KURODA, Kawasaki-shi (JP); Suguru NAGAOKA, Kawasaki-shi (JP)

(73) Assignee: AJINOMOTO CO., INC., Tokyo (JP)

(21) Appl. No.: 17/472,950

(22) Filed: Sep. 13, 2021

(30) Foreign Application Priority Data
Sep. 14, 2020 (JP) 2020-154152

(51) Int. Cl. A23L 7/109

(52) U.S. Cl. CPC A23L 7/11

(57) ABSTRACT

An outer skin containing rice flour and lecithin for a filling-wrapping food can suppress both the sticking (stickiness) of a dough to a roller during rolling and the falling over of a filling-wrapping food during molding, even when produced without using gluten or a food material (e.g., wheat flour, etc.) capable of producing gluten.

### CROSS REFERENCES TO RELATED APPLICATIONS

This application claims priority to Japanese Patent Application No. 2020-154152, filed on Sep. 14, 2020, which is incorporated herein by reference in its entirety.

### BACKGROUND OF THE INVENTION

### Field of the Invention

The present invention relates to compositions for outer skins of filling-wrapping foods. The present invention also relates to outer skins for filling-wrapping foods. The present invention further relates to filling-wrapping foods.

### Discussion of the Background

Gluten produced by kneading wheat flour with water causes wheat allergies. To prevent wheat allergies, it has been attempted in recent years to refrain from using wheat flour or gluten in producing foods that have conventionally been produced using wheat flour or gluten; instead, such foods are produced using grain flour other than wheat flour (see JP-A-2019-118318; WO 2004/080186; and JP-A-2007-215401, all of which are incorporated herein by reference in their entireties). However, food dough produced using grain flour other than wheat flour, instead of wheat flour, often causes problems in the industrialization steps due to remarkable changes in the dough properties.

### SUMMARY OF THE INVENTION

Filling-wrapping foods such as gyoza dumplings and the like are generally produced by covering an inside filling with an outer skin mainly composed of a wheat flour. The present inventors attempted to produce an outer skin for a filling-wrapping food without using wheat flour but using rice flour. However, they found that the obtained outer skin tended to lose flexibility with the lapse of time and, as shown in the Examples described later, a filling-wrapping food produced by covering the inside filling with the outer skin that loses flexibility with the lapse of time fails to maintain the shape of the resulting filling-wrapping food (e.g., non-flat bottom surface, etc.). A filling-wrapping food with a non-flat bottom surface tends to roll or fall when placed with the bottom surface down. In this case, a problem occurs that the mechanical transfer of the food into a container such as a tray cannot be performed properly and the industrial production becomes difficult. In addition, when the outer skin is produced using rice flour instead of wheat flour, as shown in the Examples described later, a problem also occurs that a dough sheet cannot be produced neatly because the dough sticks to the roller when producing the dough sheet by rolling the dough with a roll noodle-making machine or the like.

In order to solve these problems, the present inventors first considered the addition of emulsifiers such as glycerol fatty acid ester and sucrose fatty acid ester to the outer skin. However, as shown in the Examples described later, by blending the emulsifier into the outer skin, the falling over of the filling-wrapping food during molding was improved somewhat; however, the sticking (stickiness) of the dough to the roller during rolling was hardly improved. Then, the present inventors considered reducing the water content of the outer skin. In this case, as shown in the Examples described later, the sticking of the dough to the roller during rolling was suppressed somewhat, but the moldability of the outer skin became significantly worse with the lapse of time, and the problem of falling over of the filling-wrapping food during molding could not be solved.

As described above, it was not easy to simultaneously solve the two problems associated with the outer skin for the filling-wrapping food produced without using wheat flour or gluten: sticking (stickiness) of the dough to the roller during rolling and falling over of the filling-wrapping food during molding.

Accordingly, it is one object of the present invention to provide outer skins for filling-wrapping foods, which skin can suppress both the sticking (stickiness) of a dough to a roller during rolling and the falling over of a filling-wrapping food during molding, even when produced without using gluten or a food material (e.g., wheat flour, etc.) capable of producing gluten.

This and other objects, which will become apparent during the following detailed description, has been achieved by the inventors' discovery that outer skins for filling-wrapping foods, which skin can suppress both the sticking (stickiness) of a dough to a roller during rolling and the falling over of a filling-wrapping food during molding can be produced by using rice flour in combination with lecithin, and without using gluten or a food material (e.g., wheat flour, etc.) capable of producing gluten.

That is, the present invention provides the following:

(1) A composition for an outer skin of a filling-wrapping food, comprising rice flour and lecithin.
(2) The composition of (1), wherein the composition is substantially free of gluten.
(3) The composition of (1) or (2), wherein the aforementioned lecithin is derived from soybean or egg-yolk.
(4) The composition of any one of (1) to (3), wherein the aforementioned lecithin comprises at least one member selected from the group consisting of crude lecithin, refined lecithin, fractionated lecithin, enzymatically treated lecithin and hydrogenated lecithin.
(5) The composition of any one of (1) to (4), wherein a content of the aforementioned lecithin is 0.07 to 6 wt % with respect to the aforementioned composition.
(6) The composition of any one of (1) to (5), wherein an amount of phospholipid contained in the aforementioned lecithin is 0.06 to 5.8 wt % with respect to the aforementioned composition.
(7) The composition of any one of (1) to (6), further comprising crosslinked starch.
(8) The composition of (7), wherein the aforementioned crosslinked starch comprises distarch phosphate.
(9) An outer skin for a filling-wrapping food, comprising rice flour and lecithin.
(10) The outer skin of (9), wherein the outer skin is substantially free of gluten.
(11) The outer skin of (9) or (10), wherein the aforementioned lecithin is derived from soybean or egg-yolk.
(12) The outer skin of any one of (9) to (11), wherein the aforementioned lecithin comprises at least one member selected from the group consisting of crude lecithin, refined lecithin, fractionated lecithin, enzymatically treated lecithin and hydrogenated lecithin.
(13) The outer skin of any one of (9) to (12), wherein a content of the aforementioned lecithin is 0.05 to 4.2 wt % with respect to the aforementioned outer skin.
(14) The outer skin of any one of (9) to (13), wherein an amount of phospholipid contained in the aforementioned lecithin is 0.04 to 4 wt % with respect to the aforementioned outer skin.
(15) The outer skin of any one of (9) to (14), further comprising crosslinked starch.
(16) The outer skin of (15), wherein the aforementioned crosslinked starch comprises distarch phosphate.
(17) The outer skin of any one of (9) to (16), wherein a water content of the aforementioned outer skin is 15 to 45 wt % with respect to the aforementioned outer skin.
(18) A filling-wrapping food comprising at least an inside filling and an outer skin covering the inside filling, wherein the outer skin comprises rice flour and lecithin.
(19) The filling-wrapping food of (18), wherein the aforementioned outer skin is substantially free of gluten.
(20) The filling-wrapping food of (18) or (19), wherein the aforementioned lecithin is derived from soybean or egg-yolk.
(21) The filling-wrapping food of any one of (18) to (20), wherein the aforementioned lecithin comprises at least one member selected from the group consisting of crude lecithin, refined lecithin, fractionated lecithin, enzymatically treated lecithin and hydrogenated lecithin.
(22) The filling-wrapping food of any one of (18) to (21), wherein a content of lecithin in the aforementioned outer skin is 0.05 to 4.2 wt % with respect to the aforementioned outer skin.
(23) The filling-wrapping food of any one of (18) to (22), wherein an amount of phospholipid contained in the aforementioned lecithin is 0.04 to 4 wt % with respect to the aforementioned outer skin.
(24) The filling-wrapping food of any one of (18) to (23), wherein the aforementioned outer skin further comprises crosslinked starch.
(25) The filling-wrapping food of (24), wherein the aforementioned crosslinked starch comprises distarch phosphate.
(26) The filling-wrapping food of any one of (18) to (25), wherein a water content of the aforementioned outer skin is 15 to 45 wt % with respect to the aforementioned outer skin.

### Advantageous Effects of Invention

According to the present invention, an outer skin for a filling-wrapping food, which skin can suppress both the sticking (stickiness) of a dough to a roller during rolling and the falling over of a filling-wrapping food during molding, even when produced without using gluten or a food material (e.g., wheat flour, etc.) capable of producing gluten can be provided.

The present invention can also provide a composition for an outer skin of a filling-wrapping food, which can suppress both the sticking (stickiness) of a dough to a roller during rolling and the falling over of a filling-wrapping food during molding, and which can be preferably used for the production of an outer skin for a filling-wrapping food.

The present invention can also provide a filling-wrapping food in which an inside filling is covered with an outer skin capable of suppressing both the sticking (stickiness) of a dough to a roller during rolling and the falling over of a filling-wrapping food during molding.

### DETAILED DESCRIPTION OF THE PREFERRED EMBODIMENTS

The composition for an outer skin of a filling-wrapping food of the present invention (sometimes to be referred to as “the composition of the present invention” in the present specification) is mainly characterized in that it contains rice flour and lecithin.

In the present invention, the “filling-wrapping food” refers to a food product having at least an inside filling and an outer skin to cover (wrap) the inside filling. Specific examples include gyoza dumpling, xiaolongbao dumpling, shaomai dumpling, wonton, spring roll, baozi dumpling, ravioli and the like.

In the present invention, the “composition for an outer skin of a filling-wrapping food” refers to a mixture (premix) of raw materials other than water in the raw materials of the outer skin for a filling-wrapping food. As mentioned below, a “dough” is obtained by kneading the composition for an outer skin of a filling-wrapping food together with water, and the “outer skin” is obtained by roll-forming the dough (to be also referred to as the outer skin for a filling-wrapping food in the present invention). The obtained outer skin may be further cut or punched into a desired shape.

In the present invention, the “rice flour” refers to a food material obtained by milling rice into flour (that is, pulverized into a powder). The rice flour can be classified into those that have been processed (e.g., physical treatment, chemical treatment, enzymatic treatment, etc.) and those that have not been processed. In the present invention, the former (processed rice flour) is referred to as “modified rice flour”, and the latter (unprocessed rice flour) is referred to as “unmodified rice flour”. Among the modified rice flours, those that have been at least gelatinized are referred to as “pregelatinized rice flour”. The “rice flour” in the present specification means rice flour in a broad sense, and includes modified rice flour and unmodified rice flour. The rice flour to be used in the present invention includes, for example, rice starch isolated and purified from rice.

In the present invention, the kind of the rice flour to be used is not particularly limited and may be any of the unmodified rice flour and the modified rice flour. The modified rice flour to be used in the present invention is not particularly limited as long as it is obtained by processing rice flour (e.g., physical treatment, chemical treatment, enzymatic treatment, etc.), and includes, for example, pregelatinized rice flour and the like. The rice flour to be used in the present invention may contain only one of the unmodified rice flour and the modified rice flour, or both of the unmodified rice flour and the modified rice flour.

The form of the rice flour to be used in the present invention is generally a powder (form in which a plurality of particles are aggregated). The particle size of the rice flour to be used in the present invention is not particularly limited, and the rice flour to be used in the present invention may contain granulated rice flour.

The production method of the rice flour to be used in the present invention is not particularly limited, and it can be produced by a method known per se or a method analogous thereto.

The kind of the raw material rice of the rice flour to be used in the present invention is not particularly limited and may be any of non-glutinous rice and glutinous rice. The origin and variety of the raw material rice of the rice flour to be used in the present invention are not particularly limited, and the raw material rice of the rice flour to be used in the present invention may be new rice, old rice, very old rice or the like. The degree of rice polishing of the raw material rice of the rice flour to be used in the present invention is also not particularly limited, and polished rice after rice polishing, or unpolished rice or the like may be used.

Among the rice flours that can be used in the present invention, unmodified rice flour can be produced, for example, by washing the raw material rice to remove the rice bran, immersing and tempering (ageing) as necessary to adjust the water content, pulverizing using a flour mill (e.g., roll grinding machine, stamp mill grinding machine, etc.), appropriately sieving, and the like.

Among the rice flours that can be used in the present invention, pregelatinized rice flour may be obtained, for example, by washing polished glutinous rice with water, soaking same in water, followed by steaming into rice cake, baking same in white, and then crushing same (Kanbaiko, etc.); by steam cooking glutinous rice, drying same, roasting same, and milling same (Johayako, etc.); by steam cooking non-glutinous rice, drying same, roasting same, and milling same (Namihayako, etc.); by soaking polished glutinous rice in water, steaming and drying same to give dried boiled rice, roughly crushing same (Domyojiko, etc.); by washing glutinous rice with water, drying same, followed by roasting and milling without steam cooking (Rakuganko, etc.); by soaking glutinous rice in water, steaming and drying same, followed by pulverization and roasting little by little (Jonanko, etc.); by heating non-glutinous rice or glutinous rice, and pulverizing same; or the like. In addition, the production facility of the pregelatinized rice flour to be used in the present invention is not particularly limited, and pregelatinized rice flour obtained by, for example, a method of gelatinizing and drying rice flour slurry with a drum dryer, a method of adding water to rice flour and pressurizing and heat gelatinizing same with an extruder, a method of heating and gelatinizing rice flour slurry and drying same with a spray dryer, or the like may be used in the present invention.

In the present invention, commercially available rice flour may also be used.

In one embodiment, the rice flour to be used in the present invention may contain at least one member selected from the group consisting of unmodified rice flour and pregelatinized rice flour, or both of these.

The content of the rice flour in the composition of the present invention is not particularly limited as long as the outer skin for a filling-wrapping food can be produced. It is generally not less than 50 wt %, preferably not less than 55 wt %, more preferably not less than 60 wt %, particularly preferably not less than 70 wt %, based on the composition of the present invention. The content of the rice flour in the composition of the present invention is generally not more than 98 wt %, preferably not more than 97 wt %, more preferably not more than 95 wt %, based on the composition of the present invention.

In the present invention, the “lecithin” refers to a substance containing phospholipids (e.g., phosphatidyl choline, phosphatidyl ethanolamine, phosphatidyl inositol, phosphatidic acid, etc.) derived from animals and plants as a main component. The lecithin to be used in the present invention may contain one kind of phospholipid, or plural kinds (two kinds or more) of phospholipids. The derivation of the lecithin to be used in the present invention is not particularly limited and may be derived from any animal or plant. Examples of the animals and plants that can be used as the raw material of lecithin include soybean, egg-yolk, rape seed, corn, sunflower, rice bran and the like. The lecithin to be used in the present invention is preferably derived from soybean or egg-yolk. The lecithin to be used in the present invention may be derived from any one kind of the above-mentioned animals and plants, or two or more lecithins of different origins may be used in combination.

The kind of the lecithin to be used in the present invention is not particularly limited. Examples thereof include crude lecithin containing simple lipid, etc. in addition to phospholipid; refined lecithin obtained by removing simple lipid, etc. from crude lecithin to increase the purity of phospholipid (also called high purity lecithin); fractionated lecithin obtained by applying crude lecithin, etc. to solvent fractionation to change concentration of a specific phospholipid; enzymatically treated lecithin obtained by enzymatically treating crude lecithin, etc. (including enzymatically decomposed lecithin); hydrogenated lecithin obtained by hydrogenating crude lecithin, etc.; hydroxylated lecithin obtained by introducing a hydroxyl group into crude lecithin, etc.; acetylated lecithin obtained by introducing an acetyl group into crude lecithin, etc.; and the like. Among these, crude lecithin, refined lecithin, fractionated lecithin, enzymatically treated lecithin, and hydrogenated lecithin are preferred. These lecithins may be used alone or two or more kinds thereof may be used in combination.

In the present invention, the HLB value of the lecithin to be used is not particularly limited and is generally 1 to 18, preferably 3 to 15.

In the present invention, the “HLB value” refers to a hydrophile-lipophile balance, and is obtained according to the calculation formula proposed by W. C. Griffin (W. C. Griffin, J. Soc. Cosmetic Chemists, 1, 311 (1949), which is incorporated herein by reference in its entirety).

The form of the lecithin to be used in the present invention is not particularly limited and may be any form. For example, powder, paste, bulk and the like can be mentioned.

The production method of the lecithin to be used in the present invention is not particularly limited and the lecithin can be produced by a method known per se or a method analogous thereto. A commercially available product may also be used.

To suppress both the sticking (stickiness) of a dough to a roller during rolling and the falling over of a filling-wrapping food during molding, the content of lecithin in the composition of the present invention is preferably not less than 0.07 wt %, more preferably not less than 0.1 wt %, further preferably not less than 0.2 wt %, particularly preferably not less than 0.3 wt %, based on the composition of the present invention. In addition, to suppress both the sticking (stickiness) of a dough to a roller during rolling and the falling over of a filling-wrapping food during molding, the content of lecithin in the composition of the present invention is preferably not more than 6 wt %, more preferably not more than 4 wt %, further preferably not more than 2 wt %, particularly preferably not more than 1 wt %, based on the composition of the present invention.

To suppress both the sticking (stickiness) of a dough to a roller during rolling and the falling over of a filling-wrapping food during molding, the amount of phospholipid contained in lecithin in the composition of the present invention is preferably not less than 0.06 wt %, more preferably not less than 0.1 wt %, particularly preferably not less than 0.28 wt %, based on the composition of the present invention. In addition, to suppress both the sticking (stickiness) of a dough to a roller during rolling and the falling over of a filling-wrapping food during molding, the amount of phospholipid contained in lecithin in the composition of the present invention is preferably not more than 5.8 wt %, more preferably not more than 3.9 wt %, further preferably not more than 1.9 wt %, particularly preferably not more than 0.7 wt %, based on the composition of the present invention.

The composition of the present invention may contain crosslinked starch in addition to the rice flour and lecithin. The composition of the present invention containing crosslinked starch can further reduce the sticking (stickiness) of a dough to a roller during rolling.

Examples of the crosslinked starch that can be contained in the composition of the present invention include distarch phosphate, acetylated distarch adipate, acetylated distarch phosphate, hydroxypropyl distarch phosphate, phosphated distarch phosphate and the like, preferably distarch phosphate. These crosslinked starches may be used alone or two or more kinds thereof may be used in combination.

The form of the crosslinked starch that can be contained in the composition of the present invention is preferably a powder. The particle size of the crosslinked starch is not particularly limited, and the crosslinked starch may contain granulated one.

The production method of the crosslinked starch that can be contained in the composition of the present invention is not particularly limited, and it can be produced by a method known per se or a method analogous thereto. The kind of the starch to be the raw material of the crosslinked starch is not particularly limited. Examples thereof include wheat starch, corn starch, waxy corn starch, tapioca starch, rice starch, sago palm starch, potato starch, sweet potato starch, mung bean starch and the like. By applying a crosslinking treatment to the starch by a method known per se or a method analogous thereto, and the like, crosslinked starch can be produced. The crosslinked starch may be subjected to other treatment (e.g., physical treatment, chemical treatment, enzymatic treatment, etc.) in addition to the crosslinking treatment. As a crosslinked starch that can be contained in the composition of the present invention, a commercially available product may also be used. In the present invention, since rice starch is contained in the rice flour as mentioned above, rice starch that underwent a crosslinking treatment is contained in the modified rice flour and is not contained in crosslinked starch in the present invention.

When the composition of the present invention contains crosslinked starch, the content of the crosslinked starch in the composition of the present invention is preferably not less than 1 wt %, more preferably not less than 5 wt %, particularly preferably not less than 10 wt %, based on the composition of the present invention. In this case, the content of the crosslinked starch in the composition of the present invention is preferably not more than 50 wt %, more preferably not more than 35 wt %, particularly preferably not more than 25 wt %, based on the composition of the present invention.

The composition of the present invention may contain a thickening polysaccharide in addition to rice flour and lecithin, or rice flour, lecithin and crosslinked starch. By containing a thickening polysaccharide, the composition of the present invention imparts appropriate bindability to the dough, thus affording a good mouthfeel rich in viscoelasticity.

The kind of the thickening polysaccharide that can be contained in the composition of the present invention is not particularly limited. Examples thereof include alginic acids (e.g., alginic acid, alginic acid salt, alginic acid ester, etc.), xanthan gum, guar gum, locust bean gum, tara gum, gellan gum, carrageenan, gum tragacanth, gum arabic, caraya gum, tamarind seed gum, psyllium seed gum, curdlan, pectin, glucomannan, agar, pullulan, cellulose derivative (e.g., methylcellulose, carboxymethylcellulose, hydroxypropyl methylcellulose), soybean polysaccharides, chitin, chitosan and the like. These thickening polysaccharides may be used alone or two or more kinds thereof may be used in combination.

The form of the thickening polysaccharide that can be contained in the composition of the present invention is preferably a powder. The particle size of the thickening polysaccharide is not particularly limited, and the thickening polysaccharide may contain granulated one.

The production method of the thickening polysaccharide that can be contained in the composition of the present invention is not particularly limited, and it can be produced by a method known per se or a method analogous thereto. A commercially available product may also be used.

When the composition of the present invention contains a thickening polysaccharide, the content of the thickening polysaccharide in the composition of the present invention is preferably not less than 0.2 wt %, more preferably not less than 0.4 wt %, particularly preferably not less than 0.7 wt %, based on the composition of the present invention, to impart preferable bindability. In this case, the content of the thickening polysaccharide in the composition of the present invention is preferably not more than 7.5 wt %, more preferably not more than 4.5 wt %, particularly preferably not more than 3 wt %, based on the composition of the present invention, from the aspect of the suppression of the sticking of a dough and an outer skin to a tool or facility during production of the outer skin and covering of the inside filling with the outer skin.

The composition of the present invention is preferably substantially free of gluten. In the present invention, that a composition for an outer skin of a filling-wrapping food is “substantially free” of gluten means either that (1) the composition does not at all contain gluten, or a food material capable of producing gluten (e.g., wheat flour etc.), or that (2) the composition contains gluten, or a food material capable of producing gluten in a very small amount (generally not more than 0.1 wt %, preferably not more than 0.01 wt %, based on the composition for an outer skin of a filling-wrapping food), which does not cause a problem in wheat allergy. In addition, the “food material capable of producing gluten” refers to a food material that produces gluten by kneading with water added thereto, and specific examples include wheat flour and the like.

The composition of the present invention may contain a raw material generally used for the preparation of an outer skin for a filling-wrapping food (preferably excluding gluten, and a food material capable of producing gluten) and the like in addition to rice flour, lecithin, crosslinked starch, and thickening polysaccharides. Examples of the raw material include a powder raw material such as grain flour other than rice flour, salt, saccharides, oil and fat (liquid oil and fat, oil and fat powder, oil and fat emulsion), egg-yolk powder, albumin powder, whole egg powder, powdered skim milk, amino acid, animal or plant protein, dietary fiber, emulsifier, seasoning, vitamins, minerals, dye, flavor, dextrin, calcinated calcium, preservative, antioxidant, pH adjuster, enzyme agent or the like. These raw materials may each be used alone or two or more kinds thereof may be used in combination.

The production method of the composition of the present invention is not particularly limited, and it can be produced by a method known per se or a method analogous thereto. For example, the composition of the present invention can be produced by mixing rice flour, lecithin and other raw materials, and the like.

The production method of the outer skin by using the composition of the present invention as a raw material is not particularly limited, and it can be produced by a method known per se or a method analogous thereto. For example, the outer skin can be produced by adding water to the composition of the present invention, kneading the mixture, roll-forming the obtained dough with a rolling machine (e.g., roll noodle-making machine, etc.), then punching out the obtained dough sheet (roll-formed product) in a desired shape, and the like. The amount of water to be added to the composition of the present invention when producing the outer skin is generally 20 to 60 parts by weight, preferably 30 to 50 parts by weight, per 100 parts by weight of the composition of the present invention.

The outer skin produced using the composition of the present invention as a raw material has a water content of preferably not less than 15 wt %, more preferably not less than 20 wt %, particularly preferably not less than 25 wt %, with respect to the outer skin, in order to suppress falling over of the filling-wrapping food during molding. The outer skin produced using the composition of the present invention as a raw material has a water content of preferably not more than 45 wt %, more preferably not more than 40 wt %, particularly preferably not more than 35 wt %, with respect to the outer skin, in order to suppress sticking (stickiness) of the dough to the roller during rolling.

The outer skin produced using the composition of the present invention as a raw material can suppress sticking (stickiness) of the dough to the roller during rolling. The presence or absence and the degree of sticking (stickiness) of the dough to the roller can be evaluated, for example, by visual confirmation by the expert panel, and the like, as shown in the below-mentioned Examples.

The outer skin produced using the composition of the present invention as a raw material can also suppress falling over of the filling-wrapping food during molding. The flexibility of the outer skin decreases with time, and the bottom surface of the filling-wrapping food molded using the outer skin with reduced flexibility does not become flat. When such filling-wrapping food is placed on a flat plane with the bottom surface facing down, the filling-wrapping food is tilted so that the side surface of the filling-wrapping food comes into contact with the flat plane or the filling-wrapping food collapses. This is the “falling over of the filling-wrapping food during molding” in the present invention. The falling over of the filling-wrapping food during molding can be evaluated, for example, by producing a filling-wrapping food by covering an inside filling with the outer skin left standing for a given time (e.g., 15 min after completion of rolling), placing the molded filling-wrapping food on a flat plane with the bottom surface facing down, and visual confirmation by the expert panel as to the degree of tilting of the filling-wrapping food and the presence or absence of falling over (contact of side surface of filling-wrapping food with flat plane), as shown in, for example, the below-mentioned Examples.

The present invention also provides an outer skin for a filling-wrapping food containing rice flour and lecithin (sometimes to be referred to as the “outer skin of the present invention” in the present specification).

In the present invention, “the outer skin for a filling-wrapping food” refers to an outer skin to be used for the production of a filling-wrapping food.

The rice flour contained in the outer skin of the present invention is the same as one contained in the aforementioned composition of the present invention, and preferred embodiments are also the same.

The content of the rice flour in the outer skin of the present invention is not particularly limited as long as the outer skin for the filling-wrapping food can be produced. It is generally not less than 30 wt %, preferably not less than 35 wt %, more preferably not less than 40 wt %, particularly preferably not less than 45 wt %, with respect to the outer skin of the present invention. The content of the rice flour in the outer skin of the present invention is generally not more than 80 wt %, preferably not more than 75 wt %, more preferably not more than 70 wt %, with respect to the outer skin of the present invention.

The lecithin contained in the outer skin of the present invention is the same as one contained in the aforementioned composition of the present invention, and preferred embodiments are also the same.

To suppress both the sticking (stickiness) of a dough to a roller during rolling and the falling over of a filling-wrapping food during molding, the content of lecithin in the outer skin of the present invention is preferably not less than 0.05 wt %, more preferably not less than 0.07 wt %, particularly preferably not less than 0.2 wt %, based on the outer skin of the present invention. In addition, to suppress both the sticking (stickiness) of a dough to a roller during rolling and the falling over of a filling-wrapping food during molding, the content of lecithin in the outer skin of the present invention is preferably not more than 4.2 wt %, more preferably not more than 2.8 wt %, further preferably not more than 1.4 wt %, particularly preferably not more than 0.7 wt %, based on the outer skin of the present invention.

To suppress both the sticking (stickiness) of a dough to a roller during rolling and the falling over of a filling-wrapping food during molding, the amount of phospholipid contained in lecithin in the outer skin of the present invention is preferably not less than 0.04 wt %, more preferably not less than 0.07 wt %, particularly preferably not less than 0.2 wt %, based on the outer skin of the present invention. In addition, to suppress both the sticking (stickiness) of a dough to a roller during rolling and the falling over of a filling-wrapping food during molding, the amount of phospholipid contained in lecithin in the outer skin of the present invention is preferably not more than 4 wt %, more preferably not more than 2.7 wt %, further preferably not more than 1.4 wt %, particularly preferably not more than 0.7 wt %, based on the outer skin of the present invention.

The outer skin of the present invention may contain crosslinked starch in addition to the rice flour and lecithin. The outer skin of the present invention containing crosslinked starch can further reduce the sticking (stickiness) of a dough to a roller during rolling.

The crosslinked starch contained in the outer skin of the present invention is the same as one contained in the aforementioned composition of the present invention, and preferred embodiments are also the same.

When the outer skin of the present invention contains crosslinked starch, the content of the crosslinked starch in the outer skin of the present invention is preferably not less than 1 wt %, more preferably not less than 3 wt %, particularly preferably not less than 5 wt %, based on the outer skin of the present invention. In this case, the content of the crosslinked starch in the outer skin of the present invention is preferably not more than 30 wt %, more preferably not more than 25 wt %, particularly preferably not more than 20 wt %, based on the outer skin of the present invention.

The outer skin of the present invention may contain thickening polysaccharide in addition to rice flour and lecithin, or rice flour, lecithin and crosslinked starch. By containing thickening polysaccharide, the outer skin of the present invention imparts appropriate bindability to the dough, thus affording a good mouthfeel rich in viscoelasticity.

The thickening polysaccharide contained in the outer skin of the present invention is the same as one contained in the aforementioned composition of the present invention, and preferred embodiments are also the same.

When the outer skin of the present invention contains a thickening polysaccharide, the content of the thickening polysaccharide in the outer skin of the present invention is preferably not less than 0.1 wt %, more preferably not less than 0.3 wt %, particularly preferably not less than 0.5 wt %, based on the outer skin of the present invention, to impart preferable bindability. In this case, the content of the thickening polysaccharide in the outer skin of the present invention is preferably not more than 5 wt %, more preferably not more than 3 wt %, particularly preferably not more than 2 wt %, based on the outer skin of the present invention, from the aspect of the suppression of the sticking to a tool or facility during molding.

The outer skin of the present invention is preferably substantially free of gluten. In the present invention, that an outer skin is “substantially free” of gluten means either that (1) the composition does not at all contain gluten, or a food material capable of producing gluten (e.g., wheat flour etc.), or that (2) the composition contains gluten, or a food material capable of producing gluten in a very small amount (generally not more than 0.1 wt %, preferably not more than 0.01 wt %, based on the outer skin), which does not cause a problem in wheat allergy, as in the aforementioned composition for the outer skin.

The outer skin of the present invention may contain a raw material generally used for the preparation of an outer skin for a filling-wrapping food (preferably excluding gluten, and a food material capable of producing gluten) and the like in addition to rice flour, lecithin, crosslinked starch, and thickening polysaccharides. Examples of the raw material include a powder raw material such as grain flour other than rice flour, salt, saccharides, oil and fat (liquid oil and fat, oil and fat powder, oil and fat emulsion), egg-yolk powder, albumin powder, whole egg powder, powdered skim milk, amino acid, animal or plant protein, dietary fiber, emulsifier, seasoning, vitamins, minerals, dye, flavor, dextrin, calcinated calcium, preservative, antioxidant, pH adjuster, enzyme agent or the like. These raw materials may each be used alone or two or more kinds thereof may be used in combination.

The water content of the outer skin of the present invention is preferably not less than 15 wt %, more preferably not less than 20 wt %, particularly preferably not less than 25 wt %, with respect to the outer skin of the present invention, in order to suppress falling over of the filling-wrapping food during molding. The water content of the outer skin of the present invention is preferably not more than 45 wt %, more preferably not more than 40 wt %, particularly preferably not more than 35 wt %, with respect to the outer skin of the present invention, in order to suppress sticking (stickiness) of the dough to the roller during rolling.

The thickness of the outer skin of the present invention is not particularly limited and can be appropriately set according to the kind of the filling-wrapping food and the like. It is generally 0.3 to 3.0 mm, preferably 0.5 to 2.5 mm. The shape and size of the outer skin of the present invention are not particularly limited, and can be appropriately set according to the kind of the filling-wrapping food and the like.

The production method of the outer skin of the present invention is not particularly limited, and it can be produced by a method known per se or a method analogous thereto. For example, it can be produced by adding water to a premix containing rice flour and lecithin (the composition of the present invention may also be used), kneading the mixture, and roll-forming the obtained dough with a rolling machine (e.g., roll noodle-making machine, etc.) (optionally further including punching out the dough sheet in a desired shape, and the like as necessary). Therefore, the outer skin of the present invention may be a roll-formed product. In the present invention, the “roll-formed product” is a sheet-like formed product obtained by roll-forming a raw material with viscoelasticity, such as dough and the like.

The outer skin of the present invention can be frozen and provided as a frozen product. The outer skin of the present invention can also be provided as a refrigerated food (including a chilled food).

The outer skin of the present invention is preferably used for the production of a filling-wrapping food, and the present invention also provides a filling-wrapping food containing at least an inside filling and an outer skin covering the inside filling, wherein the outer skin includes the outer skin of the present invention (that is, outer skin containing rice flour and lecithin) (sometimes to be referred to as “the filling-wrapping food of the present invention” in the present specification).

The kind of the filling-wrapping food of the present invention is not particularly limited, and examples thereof include gyoza dumpling, xiaolongbao dumpling, shaomai dumpling, wonton, spring roll, baozi dumpling, ravioli and the like, with preference given to gyoza dumpling.

The inside filling of the filling-wrapping food of the present invention may be appropriately produced according to the kind of the filling-wrapping food. The raw materials and production methods used for the production are not particularly limited.

In the filling-wrapping food of the present invention, the outer skin may cover the entire inside filling, or may cover a part of the inside filling.

The production method of the filling-wrapping food of the present invention is not particularly limited as long as it includes covering the inside filling with the outer skin of the present invention (that is, outer skin containing rice flour and lecithin), and it can be produced by a method known per se or a method analogous thereto, according to the kind of the filling-wrapping food, and the like.

The filling-wrapping food of the present invention can be frozen and provided to consumers as a frozen product. The filling-wrapping food of the present invention can also be provided as a refrigerated food (including a chilled food). The filling-wrapping food of the present invention may be provided after heat cooking (e.g., baked, steamed, boiled, fried, etc.) or may be provided without heat cooking.

Other features of the invention will become apparent in the course of the following descriptions of exemplary embodiments which are given for illustration of the invention and are not intended to be limiting thereof.

### EXAMPLES

Unless particularly indicated, all the raw materials used in the following Examples are commercially available for food products.

### Experimental Example 1

production of outer skin for filling-wrapping food

### Experimental Plot 1

Unmodified rice flour (manufactured by Namisato Corporation, “Okome No Kona Hakuriki Komeko R”), pregelatinized rice flour (manufactured by takai-foods. co. ltd., “JU-800A”), alginic acid ester (manufactured by KIMICA Corporation, “Konbusan 501”) and salad oil were mixed in the amounts shown in the following Table 1 (unit: parts by weight) to produce a composition for an outer skin of a filling-wrapping food (premix). To the composition for outer skin was added city water in the amount shown in the following Table 1, and they were kneaded at ordinary temperature for 5 min using a mixer (manufactured by FMI Corporation, “KitchenAid KSM5”) to produce a dough. The dough was rolled to a thickness of 0.75 mm with a roll noodle-making machine (manufactured by Tosei Kogyo Co., Ltd., “FNH-21”) at ordinary temperature to produce a dough sheet (roll-formed product). The dough sheet was cut into a 82 mmX92 mm ellipse to produce an outer skin for a filling-wrapping food (hereinafter to be also referred to as the “outer skin of Experimental plot 1”).

### Experimental Plot 2

In the same manner as in Experimental plot 1 except that a composition for an outer skin of a filling-wrapping food (premix) was produced using soybean-derived crude lecithin (manufactured by Tsuji Oil Mills co., Ltd., “SLP-paste”, phospholipid content: not less than 60 wt %, HLB value: 7 to 9) in addition to unmodified rice flour, pregelatinized rice flour, alginic acid ester and salad oil and mixing them in the amounts shown in the following Table 1 (unit: parts by weight), the outer skin for a filling-wrapping food (hereinafter to be also referred to as the “outer skin of Experimental plot 2”) was produced.

### Experimental Plot 3

In the same manner as in Experimental plot 1 except that a composition for an outer skin of a filling-wrapping food (premix) was produced using soybean-derived refined lecithin (manufactured by Tsuji Oil Mills co., Ltd., “SLP-White”, phospholipid content: not less than 96 wt %, HLB value: 7 to 9) in addition to unmodified rice flour, pregelatinized rice flour, alginic acid ester and salad oil and mixing them in the amounts shown in the following Table 1 (unit: parts by weight), the outer skin for a filling-wrapping food (hereinafter to be also referred to as the “outer skin of Experimental plot 3”) was produced.

### Experimental Plot 4

In the same manner as in Experimental plot 1 except that a composition for an outer skin of a filling-wrapping food (premix) was produced using soybean-derived refined enzymatically treated lecithin (manufactured by Tsuji Oil Mills co., Ltd., “SLP-White Lyso”, phospholipid content: 95 to 98 wt %, HLB value: 10 to 12) in addition to unmodified rice flour, pregelatinized rice flour, alginic acid ester and salad oil and mixing them in the amounts shown in the following Table 1 (unit: parts by weight), the outer skin for a filling-wrapping food (hereinafter to be also referred to as the “outer skin of Experimental plot 4”) was produced.

### Experimental Plot 5

In the same manner as in Experimental plot 1 except that a composition for an outer skin of a filling-wrapping food (premix) was produced using egg-yolk-derived crude lecithin (manufactured by Kewpie Corporation, “egg-yolk lecithin PL-30s”, phospholipid content: around 30 wt %, HLB value: around 8) in addition to unmodified rice flour, pregelatinized rice flour, alginic acid ester and salad oil and mixing them in the amounts shown in the following Table 1 (unit: parts by weight), the outer skin for a filling-wrapping food (hereinafter to be also referred to as the “outer skin of Experimental plot 5”) was produced.

### Experimental Plots 6 and 7

In the same manner as in Experimental plot 1 except that a composition for an outer skin of a filling-wrapping food (premix) was produced using hydrogenated rapeseed oil fatty acid mono- and di-glycerides (manufactured by Taiyo Kagaku Co., Ltd., “Sunsoft No. 1030”, HLB value: 2.7) in addition to unmodified rice flour, pregelatinized rice flour, alginic acid ester and salad oil and mixing them in the amounts shown in the following Table 2 (unit: parts by weight), and that city water in the amounts shown in the following Table 2 was added to the composition for the outer skin, the outer skins for a filling-wrapping food (hereinafter to be also referred to as “the outer skin of Experimental plot 6” and “the outer skin of Experimental plot 7”) were produced. The outer skin of Experimental plot 6 and the outer skin of Experimental plot 7 are different in the amount of city water added to the composition for the outer skin, as shown in Table 2.

### Experimental Plots 8 and 9

In the same manner as in Experimental plot 1 except that a composition for an outer skin of a filling-wrapping food (premix) was produced using succinylated monoglycerides (manufactured by Taiyo Kagaku Co., Ltd., “Sunsoft No. 681SPV”, HLB value: 9.5) in addition to unmodified rice flour, pregelatinized rice flour, alginic acid ester and salad oil and mixing them in the amounts shown in the following Table 2 (unit: parts by weight), and that city water in the amounts shown in the following Table 2 was added to the composition for the outer skin, the outer skins for a filling-wrapping food (hereinafter to be also referred to as “the outer skin of Experimental plot 8” and “the outer skin of Experimental plot 9”) were produced. The outer skin of Experimental plot 8 and the outer skin of Experimental plot 9 are different in the amount of city water added to the composition for the outer skin, as shown in Table 2.

### Experimental Plots 10 and 11

In the same manner as in Experimental plot 1 except that a composition for an outer skin of a filling-wrapping food (premix) was produced using diglycerin mono- and di-stearate (manufactured by Taiyo Kagaku Co., Ltd., “Sunsoft Q18B”, HLB value: 6.5) in addition to unmodified rice flour, pregelatinized rice flour, alginic acid ester and salad oil and mixing them in the amounts shown in the following Table 2 (unit: parts by weight), and that city water in the amounts shown in the following Table 2 was added to the composition for the outer skin, the outer skins for a filling-wrapping food (hereinafter to be also referred to as “the outer skin of Experimental plot 10” and “the outer skin of Experimental plot 11”) were produced. The outer skin of Experimental plot 10 and the outer skin of Experimental plot 11 are different in the amount of city water added to the composition for the outer skin, as shown in Table 2.

### Experimental Plots 12 and 13

In the same manner as in Experimental plot 1 except that a composition for an outer skin of a filling-wrapping food (premix) was produced using sucrose fatty acid ester (manufactured by Mitsubishi-Chemical Foods Corporation, “Ryoto Sugar Ester S-1570”, HLB value: 15) in addition to unmodified rice flour, pregelatinized rice flour, alginic acid ester and salad oil and mixing them in the amounts shown in the following Table 2 (unit: parts by weight), and that city water in the amounts shown in the following Table 2 was added to the composition for the outer skin, the outer skins for a filling-wrapping food (hereinafter to be also referred to as “the outer skin of Experimental plot 12” and “the outer skin of Experimental plot 13”) were produced. The outer skin of Experimental plot 12 and the outer skin of Experimental plot 13 are different in the amount of city water added to the composition for the outer skin, as shown in Table 2.

TABLE 1

| | Experimental plot | | | | |
|---|---|---|---|---|---|
| raw material | 1 | 2 | 3 | 4 | 5 |
| unmodified rice flour | 305 | 305 | 305 | 305 | 305 |
| pregelatinized rice flour | 40 | 40 | 40 | 40 | 40 |
| alginic acid ester | 5.0 | 5.0 | 5.0 | 5.0 | 5.0 |
| salad oil 8.5 | 8.5 | 8.5 | 8.5 | 8.5 | |
| soybean crude lecithin | | 2.11 | | | |
| soybean refined lecithin | | | 1.32 | | |
| soybean-purified enzyme- | | | | 1.30 | |
| treated lecithin | | | | | |
| egg-yolk crude lecithin | | | | | 4.22 |
| city water | 150 | 150 | 150 | 150 | 150 |
| total (parts by weight) | 508.5 | 510.6 | 509.8 | 509.8 | 512.7 |

TABLE 2

| | Experimental plot | | | | | | | |
|---|---|---|---|---|---|---|---|---|
| raw material | 6 | 7 | 8 | 9 | 10 | 11 | 12 | 13 |
| unmodified | 305 | 305 | 305 | 305 | 305 | 305 | 305 | 305 |
| rice flour | | | | | | | | |
| pregelatinized | 40 | 40 | 40 | 40 | 40 | 40 | 40 | 40 |
| rice flour | | | | | | | | |
| alginic acid ester | 5.0 | 5.0 | 5.0 | 5.0 | 5.0 | 5.0 | 5.0 | 5.0 |
| salad oil | 8.5 | 8.5 | 8.5 | 8.5 | 8.5 | 8.5 | 8.5 | 8.5 |
| hydrogenated | 1.26 | 1.26 | | | | | | |
| rapeseed oil | | | | | | | | |
| fatty acid | | | | | | | | |
| mono- and | | | | | | | | |
| di-glycerides | | | | | | | | |
| succinylated | | | 1.26 | 1.26 | | | | |
| monoglycerides | | | | | | | | |
| diglycerin | | | | | 1.26 | 1.26 | | |
| mono- and di-stearate | | | | | | | | |
| sucrose fatty acid ester | | | | | | | 1.26 | 1.26 |
| city water | 150 | 135 | 150 | 135 | 150 | 130 | 150 | 130 |
| total (parts by weight) | 509.8 | 494.8 | 509.8 | 494.8 | 509.8 | 489.8 | 509.8 | 489.8 |

### Evaluation of Stickiness (Sticking of Dough to Roller During Rolling)

The outer skins of Experimental plots 1 to 13 were evaluated for the degree of sticking (stickiness) of a dough to a roller when the dough was rolled using a roll noodle-making machine in the production thereof. Specifically, a panel of three experts graded the stickiness by consensus in 1-point increments based on the following criteria. In the evaluation of stickiness, 3 to 5 points were evaluated as acceptable (D), and 1 to 2 points were evaluated as unacceptable (X).

### Evaluation Criteria of Stickiness

5: dough hardly sticks to roller

4: dough slightly sticks to roller

3: dough rather sticks to roller

2: dough sticks to roller

1: dough sticks to whole surface of roller

The results are shown in the following Table 3.

### Evaluation of Falling Over of Gyoza Dumpling During Molding (Falling Over Due to Non-Flat Bottom Surface of Gyoza Dumpling)

The outer skins of Experimental plots 1 to 13 were used to produce gyoza dumplings, and each gyoza dumpling was evaluated for falling over during molding. Specifically, the outer skins of Experimental plots 1 to 13 were rolled and then left standing for 15 min (at room temperature). An inside filling (10 g) obtained by kneading minced meat, minced vegetables, seasoning, and the like was covered with the outer skin by a mechanical molder to produce semicircular gyoza dumpling (bottom surface area: about 1000 mm²). The produced gyoza dumplings were placed on a flat plane with the bottom surface facing down and the ear (joint of folded outer skins) on the top, and a panel of three experts graded the degree of tilting of the gyoza dumpling and the presence or absence of falling over (contact of side surface of gyoza dumpling with flat plane) by consensus in 1-point increments based on the following criteria. In the evaluation of falling over of gyoza dumpling during molding, 3 to 5 points were evaluated as acceptable (◯), and 1 to 2 points were evaluated as unacceptable (X).

### Evaluation Criteria of Falling Over of Gyoza Dumpling During Molding

5: gyoza dumpling does not tilt at all

4: gyoza dumpling slightly tilts

3: gyoza dumpling somewhat tilts

2: gyoza dumpling tilts and falls over (contact of side surface of gyoza dumpling with flat plane)

1: gyoza dumpling completely collapses

The results are shown in the following Table 3.

TABLE

| evaluation | Experimental plot | | | | | | | | | | | | |
|---|---|---|---|---|---|---|---|---|---|---|---|---|---|
| item | 1 | 2 | 3 | 4 | 5 | 6 | 7 | 8 | 9 | 10 | 11 | 12 | 13 |
| stickiness | 1 | 5 | 5 | 4 | 5 | 1 | 4 | 1 | 4 | 1 | 4 | 1 | 4 |
| acceptability | x | ∘ | ∘ | ∘ | ∘ | x | ∘ | x | ∘ | x | ∘ | x | ∘ |
| falling over | 1 | 5 | 5 | 4 | 5 | 3 | 1 | 4 | 2 | 4 | 1 | 5 | 2 |
| of gyoza | | | | | | | | | | | | | |
| dumpling | | | | | | | | | | | | | |
| during | | | | | | | | | | | | | |
| molding | | | | | | | | | | | | | |
| acceptability | x | ∘ | ∘ | ∘ | ∘ | ∘ | x | ∘ | x | ∘ | x | ∘ | x |

As is clear from the results shown in Table 3, the dough of the outer skins of Experimental plots 2 to 5 produced using the composition for outer skin of the present invention containing rice flour and lecithin hardly stuck to the roller during rolling, or even if the dough stuck, the sticking was slight. These outer skins suppressed the deterioration of moldability over time, and even when gyoza dumplings were molded after leaving the dough for 15 min, the gyoza dumplings did not tilt at all or tilted only slightly when placed on a flat plane.

On the other hand, the dough of the outer skin of Experimental plot 1 produced using the composition for outer skin containing no lecithin stuck to the entire surface of the roller during rolling. The moldability of the outer skin was markedly deteriorated over time. The bottom surface of the gyoza dumplings molded after leaving the dough for 15 min did not become flat, and the gyoza dumplings completely collapsed when placed on a flat plane. The outer skins of Experimental plots 6, 8, 10 and 12 in which emulsifiers other than lecithin were used were slightly improved in the falling over of gyoza dumpling during molding. However, the sticking of the dough to the roller during rolling was not improved at all, and the dough stuck to the entire surface of the roller. In the outer skins of Experimental plots 7, 9, 11 and 13 in which emulsifiers other than lecithin were used, and the amount of water added to the composition for the outer skin was reduced (that is, the water content of the outer skin was reduced), the sticking of the dough to the roller during rolling was slightly suppressed but the moldability was markedly deteriorated over time. The bottom surface of the gyoza dumplings molded after leaving these the outer skins for 15 min did not become flat, and the gyoza dumplings tilted to fall over (contact of side surface of gyoza dumpling with flat plane) or completely collapsed when placed on a flat plane. When gyoza dumplings were produced immediately after completion of the rolling without leaving the outer skins for 15 min, and evaluated for falling over during molding, the gyoza dumplings of Experimental plots 1 to 13 did not tilt at all (5 points according to the above-mentioned evaluation criteria). In addition, when the outer skin was produced in the same manner as in Experimental plot 3 except that other thickening polysaccharide (xanthan gum, guar gum, locust bean gum, K-carrageenan, pectin, agar, methylcellulose, hydroxypropyl methylcellulose) was used instead of alginic acid ester, the sticking (stickiness) of a dough to a roller during rolling and the falling over of a filling-wrapping food during molding were both suppressed, similar to the use of alginic acid ester.

From the above results, it was confirmed that an outer skin that can suppress both the sticking (stickiness) of a dough to a roller during rolling and the falling over of a filling-wrapping food during molding can be produced by using rice flour in combination with lecithin, and without using gluten or a food material (e.g., wheat flour, etc.) capable of producing gluten.

### Experimental Example 2

### Production of Outer Skin for Filling-Wrapping Food

### Experimental Plots 14 to 17

In the same manner as in Experimental plot 1 of Experimental Example 1 except that a composition for an outer skin of a filling-wrapping food (premix) was produced using soybean-derived refined lecithin (manufactured by Tsuji Oil Mills co., Ltd., “SLP-White”, phospholipid content: not less than 96 wt %, HLB value: 7 to 9) in addition to unmodified rice flour, pregelatinized rice flour, alginic acid ester and salad oil and mixing them in the amounts shown in the following Table 4 (unit: parts by weight), the outer skins for a filling-wrapping food (hereinafter to be also respectively referred to as “the outer skin of Experimental plot 14” to “the outer skin of Experimental plot 17”) were produced.

TABLE 4

| | Experimental plot | | | |
|---|---|---|---|---|
| raw material | 14 | 15 | 16 | 17 |
| unmodified rice flour | 305 | 305 | 305 | 305 |
| pregelatinized rice | 40 | 40 | 40 | 40 |
| flour | | | | |
| alginic acid ester | 5.0 | 5.0 | 5.0 | 5.0 |
| salad oil | 8.5 | 8.5 | 8.5 | 8.5 |
| soybean refined | 0.36 | 1.44 | 3.61 | 14.94 |
| lecithin | | | | |
| city water | 150 | 150 | 150 | 150 |
| total (parts by | 508.9 | 510.0 | 512.1 | 523.5 |
| weight) | | | | |

### Evaluation of Stickiness (Sticking of Dough to Roller During Rolling)

In the same manner as in Experimental Example 1, the outer skins of Experimental plots 14 to 17 were evaluated for the degree of sticking (stickiness) of a dough to a roller when the dough was rolled using a roll noodle-making machine in the production thereof. The results are shown in the following Table 5.

### <Evaluation of Falling Over of Gyoza Dumpling During Molding (Falling Over Due to Non-Flat Bottom Surface of Gyoza Dumpling)

In the same manner as in Experimental Example 1, the outer skins of Experimental plots 14 to 17 were used to produce gyoza dumplings, and each gyoza dumpling was evaluated for falling over during molding in the same manner as in Experimental Example 1. The results are shown in the following Table 5.

TABLE 5

| | Experimental plot | | | |
|---|---|---|---|---|
| evaluation item | 14 | 15 | 16 | 17 |
| stickiness | 3 | 5 | 5 | 5 |
| acceptability | ○ | ○ | ○ | ○ |
| falling over of | 3 | 5 | 4 | 3 |
| gyoza dumpling | | | | |
| during molding | | | | |
| acceptability | ○ | ○ | ○ | ○ |

As is clear from the results shown in Table 5, in the outer skins of Experimental plots 14 to 17 produced using the composition for outer skin of the present invention containing 0.1 to 4 wt % of lecithin (lecithin content of the outer skin: 0.07 to 2.9 wt %), the sticking (stickiness) of a dough to a roller during rolling and the falling over of a filling-wrapping food during molding were both suppressed. Particularly, the outer skins of Experimental plots 15 to 17 produced using the composition for outer skin of the present invention containing 0.4 to 4 wt % of lecithin (lecithin content of the outer skin: 0.28 to 2.9 wt %) were preferable, the outer skins of Experimental plots 15, 16 produced using the composition for outer skin of the present invention containing 0.4 to 1 wt % of lecithin (lecithin content of the outer skin: 0.28 to 0.7 wt %) were more preferable, and the outer skin of Experimental plot 15 produced using the composition for outer skin of the present invention containing 0.4 wt % of lecithin (lecithin content of the outer skin: 0.28 wt %) was most preferable.

### Experimental Example 3

### Production of Outer Skin for Filling-Wrapping Food

### Experimental Plot 18

In the same manner as in Experimental plot 2 of Experimental Example 1, the outer skin for a filling-wrapping food was produced (hereinafter to be also referred to as “the outer skin of Experimental plot 18”).

### Experimental Plot 19

In the same manner as in Experimental plot 1 of Experimental Example 1 except that a composition for an outer skin of a filling-wrapping food (premix) was produced using soybean-derived refined lecithin (manufactured by Tsuji Oil Mills co., Ltd., “SLP-White”, phospholipid content: not less than 96 wt %, HLB value: 7 to 9) and corn distarch phosphate (manufactured by Tate & Lyle, “PULPIZ A”) in addition to unmodified rice flour, pregelatinized rice flour, alginic acid ester and salad oil and mixing them in the amounts shown in the following Table 6 (unit: parts by weight), the outer skin for a filling-wrapping food (hereinafter to be also referred to as the “outer skin of Experimental plot 19”) was produced.

### Experimental Plot 20

In the same manner as in Experimental plot 1 of Experimental Example 1 except that a composition for an outer skin of a filling-wrapping food (premix) was produced using soybean-derived refined lecithin (manufactured by Tsuji Oil Mills co., Ltd., “SLP-White”, phospholipid content: not less than 96 wt %, HLB value: 7 to 9) and waxy potato hydroxypropyl distarch phosphate (manufactured by Matsutani Chemical Industry Co., Ltd., “PINEAQUQ”) in addition to unmodified rice flour, pregelatinized rice flour, alginic acid ester and salad oil and mixing them in the amounts shown in the following Table 6 (unit: parts by weight), the outer skin for a filling-wrapping food (hereinafter to be also referred to as the “outer skin of Experimental plot 20”) was produced.

TABLE 6

| | Experimental plot | | |
|---|---|---|---|
| raw material | 18 | 19 | 20 |
| unmodified rice flour | 305 | 225 | 225 |
| pregelatinized rice flour | 40 | 40 | 40 |
| alginic acid ester | 5.0 | 5.0 | 5.0 |
| salad oil | 8.5 | 8.5 | 8.5 |
| soybean crude lecithin | 2.11 | | |
| soybean refined lecithin | | 1.32 | 1.32 |
| corn distarch phosphate | | 80 | |
| waxy potato hydroxypropyl | | | 80 |
| distarch phosphate | | | |
| city water | 150 | 150 | 150 |
| total (parts by weight) | 510.6 | 509.8 | 509.8 |

### Evaluation of Stickiness (Sticking of Dough to Roller During Rolling)

The outer skins of Experimental plots 19, 20 were evaluated, by comparison with the outer skin of Experimental plot 18, for the degree of sticking (stickiness) of a dough to a roller when the dough was rolled using a roll noodle-making machine in the production thereof. Specifically, a panel of three experts made evaluation of stickiness based on the following criteria.

The outer skin of Experimental plot 18 was produced in the same manner as in Experimental plot 2 of Experimental Example 1 as described above, and the “evaluation of stickiness (sticking of dough to roller during rolling)” of the outer skin of Experimental plot 2 was 5 points (dough hardly sticks to roller) as shown in the above-mentioned Table 3, and “evaluation of falling over of gyoza dumpling during molding (falling over due to non-flat bottom surface of gyoza dumpling)” was also 5 points (gyoza dumpling does not tilt at all).

### Evaluation Criteria of Stickiness

◯: compared to Experimental plot 18, the dough sticks less to the roller

□: same as Experimental plot 18

X: compared to Experimental plot 18, the dough sticks more to the roller

The results are shown in the following Table 7.

### Evaluation of Falling Over of Gyoza Dumpling During Molding (Falling Over Due to Non-Flat Bottom Surface of Gyoza Dumpling)

The outer skins of Experimental plots 18 to 20 were used to produce gyoza dumplings (hereinafter the produced gyoza dumplings are to be also referred to as “gyoza dumpling of Experimental plot 18”, “gyoza dumpling of Experimental plot 19”, “gyoza dumpling of Experimental plot 20”), and the gyoza dumplings of Experimental plots 19, 20 were evaluated for falling over during molding by comparison with the gyoza dumpling of Experimental plot 18. Specifically, using the outer skins of Experimental plots 18 to 20, semicircular gyoza dumplings were produced in the same manner as in Experimental Example 1, the produced gyoza dumplings of Experimental plots 18 to 20 were each placed on a flat surface as in Experimental Example 1, and a panel of three experts made evaluation of the degree of tilting of the gyoza dumplings of Experimental plots 19, 20, and the presence or absence of falling over (contact of side surface of gyoza dumpling with flat plane) based on the following criteria.

### Evaluation Criteria of Falling Over of Gyoza Dumpling During Molding

◯: compared to Experimental plot 18, the gyoza dumpling tilts less and falls over less

□: same as Experimental plot 18

X: compared to Experimental plot 18, the gyoza dumpling tilts more and falls over more

The results are shown in the following Table 7.

TABLE 7

| | Experimental plot | |
|---|---|---|
| evaluation item | 19 | 20 |
| stickiness | ○ | ○ |
| falling over of gyoza | □ | □ |
| dumpling during molding | | |

As is clear from the results shown in Table 7, the dough of the outer skins of Experimental plots 19, 20 produced using the composition for outer skin of the present invention further containing crosslinked starch in addition to rice flour and lecithin stuck less to the roller during rolling as compared with the outer skin of Experimental plot 18 (outer skin produced using the composition for outer skin of the present invention not containing crosslinked starch).

From the above results, it was confirmed that the sticking (stickiness) of a dough to a roller during rolling can be further reduced by using crosslinked starch with rice flour and lecithin.

### INDUSTRIAL APPLICABILITY

According to the present invention, an outer skin for a filling-wrapping food, which skin can suppress both the sticking (stickiness) of a dough to a roller during rolling and the falling over of a filling-wrapping food during molding, even when produced without using gluten or a food material (e.g., wheat flour, etc.) capable of producing gluten can be provided.

The present invention can also provide a composition for an outer skin of a filling-wrapping food, which can suppress both the sticking (stickiness) of a dough to a roller during rolling and the falling over of a filling-wrapping food during molding, and which can be preferably used as a raw material of an outer skin for a filling-wrapping food.

The present invention can also provide a filling-wrapping food in which an inside filling is covered with an outer skin capable of suppressing both the sticking (stickiness) of a dough to a roller during rolling and the falling over of a filling-wrapping food during molding.

Where a numerical limit or range is stated herein, the endpoints are included. Also, all values and subranges within a numerical limit or range are specifically included as if explicitly written out.

As used herein the words “a” and “an” and the like carry the meaning of “one or more.”

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. A composition for an outer skin of a filling-wrapping food, comprising rice flour and lecithin.

2. The composition according to claim 1, wherein said composition is substantially free of gluten.

3. The composition according to claim 1, wherein said lecithin is derived from soybean or egg-yolk.

4. The composition according to claim 1, wherein said lecithin comprises at least one member selected from the group consisting of crude lecithin, refined lecithin, fractionated lecithin, enzymatically treated lecithin and hydrogenated lecithin.

5. The composition according to claim 1, wherein a content of said lecithin is 0.07 to 6 wt % with respect to said composition.

6. The composition according to claim 1, wherein an amount of phospholipid contained in said lecithin is 0.06 to 5.8 wt % with respect to said composition.

7. The composition according to claim 1, further comprising crosslinked starch.

8. The composition according to claim 7, wherein said crosslinked starch comprises distarch phosphate.

9. An outer skin for a filling-wrapping food, comprising rice flour and lecithin.

10. The outer skin according to claim 9, wherein said outer skin is substantially free of gluten.

11. The outer skin according to claim 9, wherein a content of said lecithin is 0.05 to 4.2 wt % with respect to said outer skin.

12. The outer skin according to claim 9, wherein an amount of phospholipid contained in said lecithin is 0.04 to 4 wt % with respect to said outer skin.

13. The outer skin according to claim 9, wherein a water content of said outer skin is 15 to 45 wt % with respect to said outer skin.

14. A filling-wrapping food comprising at least an inside filling and an outer skin covering the inside filling, wherein the outer skin comprises rice flour and lecithin.

15. The filling-wrapping food according to claim 14, wherein said outer skin is substantially free of gluten.

16. The filling-wrapping food according to claim 14, wherein a content of said lecithin in said outer skin is 0.05 to 4.2 wt % with respect to said outer skin.

17. The filling-wrapping food according to claim 14, wherein an amount of phospholipid contained in said lecithin is 0.04 to 4 wt % with respect to said outer skin.

18. The filling-wrapping food according to claim 14, wherein a water content of said outer skin is 15 to 45 wt % with respect to said outer skin.

19. A method of preparing a filling-wrapping food, comprising wrapping an outer skin according to claim 9 around a filling.

20. The method according to claim 19, wherein said filling is a gyoza filling.
